(19) United States
(12) Patent Application Publication
(10) Pub. No.: US 2021/0102691 A1
(43) Pub. Date: Apr. 8, 2021

(54) Modular Linear High-Bay Light Fixture

(71) Applicant: FINTRONX, LLC, Raleigh, NC (US)

(72) Inventors: Gilmer Patrick Forbis, II, Raleigh, NC (US); Xiaobo Guo, Beijing (CN)

(73) Assignee: FINTRONX, LLC, Raleigh, NC (US)

(21) Appl. No.: 17/029,943

(22) Filed: Sep. 23, 2020

Related U.S. Application Data
(60) Provisional application No. 62/911,709, filed on Oct. 7, 2019.

(51) Int. Cl. F21V 23/00; F21S 8/06; F21V 15/01

(52) U.S. Cl. CPC F21V 23/005; F21Y 2115/10; F21V 15/01; F21S 8/06

(57) ABSTRACT

A modular linear high-bay light fixture. The modular linear high-bay light fixture may include one or more light-emitting diode (LED) drivers enclosed in a driver housing; and one or more LED light strip assemblies operatively connected to the one or more LED drivers, wherein the one or more LED light strip assemblies each may include a stack assembly enclosed in a substantially waterproof configuration.

### RELATED APPLICATIONS

This application is related and claims priority to U.S. Provisional Patent Application No. 62/911,709, entitled “Modular Linear High-Bay light-Emitting Diode (LED) Light Fixture”, filed on Oct. 7, 2019 the application of which is incorporate herein by reference in its entirety.

### TECHNICAL FIELD

The presently disclosed subject matter relates generally to lighting applications and more particularly to a modular linear high-bay light fixture.

### BACKGROUND

As compared with standard incandescent lights, fluorescent lights, and halogen lights, the main benefits of using light-emitting diode (LED) technology for lighting applications is longer life and less energy usage. For example, a 40-watt incandescent bulb or a 10- to 12-watt compact fluorescent light (CFL) bulb is needed to generate 450 lumens of light. By contrast, a 4- to 5-watt LED bulb can generate 450 lumens of light. Further, with respect to lifetime, one can expect to replace an incandescent bulb more than 40 times and a CFL bulb about 5 times over a period of 50k hours. By contrast, one can expect to replace an LED bulb only once over the same period of time.

Unfortunately, the cost of implementing LED technology for lighting applications has been prohibitive to widespread adoption. As significant advances are being made in LED technology, however, it is now becoming cost-effective to use such technology for general lighting applications.

### SUMMARY

In one embodiment, a modular linear high-bay light fixture is provided. The modular linear high-bay light fixture may include one or more light-emitting diode (LED) drivers enclosed in a driver housing; and one or more LED light strip assemblies operatively connected to the one or more LED drivers, wherein the one or more LED light strip assemblies each may include a stack assembly enclosed in a substantially waterproof configuration. The stack assembly may include a PCB housing; a PCB including an arrangement of LEDs; one or more gaskets; and a lens, wherein the one or more gaskets may provide a waterproof seal. At least one of the driver housing and the PCB housing may be made of an aluminum alloy. The PCB housing may be configured to dissipate heat away from the arrangement of LEDs on the PCB. The lens may be configured to adjust the shape of light emitted from the arrangement of LEDs. The plurality of LED light strip assemblies may be arranged in a side-by-side configuration. The plurality of LED light strip assemblies may be operatively connected to a single LED driver. The modular linear high-bay light fixture may include a plurality of LED light strip assemblies arranged in an end-to-end configuration. The plurality of LED light strip assemblies may be operatively connected to a single LED driver. At least one of the plurality of LED light strip assemblies may be operatively connected to a first LED driver, and at least one of the other ones of the plurality of LED light strip assemblies may be operatively connected to a second LED driver. A first end of a first LED light strip assembly may be operatively connected to a first LED driver and a second end of a second LED light strip assembly arranged in an end-to-end configuration with the first LED light strip assembly may be operatively connected to a second LED driver. The modular linear high-bay light fixture may include a first LED light strip assembly and a second LED light strip assembly arranged in an end-to-end configuration relative to one another; and a third LED light strip assembly and a fourth LED light strip assembly arranged in an end-to-end configuration relative to one another; and wherein the first and second LED light strip assemblies may be arranged in a side-by-side configuration relative to the third and fourth LED light strip assemblies. The driver housing may include a driver housing outer end cover and a driver housing inner end cover. The driver housing may include a substantially waterproof housing. A first end of an LED light strip assembly may be mechanically coupled to the driver inner end cover and an opposite second end of a second LED light assembly, arranged in an end-to-end configuration with the first LED light strip assembly, may be mechanically coupled to an end plate. A first end of a first LED light strip assembly may be mechanically coupled to a first driver inner end cover of a first driver housing and an opposite second end of a second LED light assembly, arranged in an end-to-end configuration with the first LED light strip assembly, may be mechanically coupled to a second driver inner cover of a second driver housing. The modular linear high-bay light fixture may further include a second driver housing. The modular linear high-bay light fixture may further include one or more of an operations controller and a communications interface operatively connected to one or both of the one or more LED drivers and one or more LED light strip assemblies. The modular linear high-bay light fixture may further include one or more of a status indicator, a battery backup, a motion sensor, and a light sensor operatively connected to one or both of the one or more LED drivers and/or one or more LED light strip assemblies.

In another embodiment, a linear high-bay light fixture is provided. The linear high-bay light fixture may include one or more modular components, wherein the one or more modular components may include one or more light-emitting diode (LED) drivers; and one or more LED light strip assemblies operatively engaged with the one or more LED drivers, and wherein the one or more LED light strip assemblies each may include a stack assembly enclosed in a substantially waterproof configuration. The stack assembly may include a PCB housing; a PCB including an arrangement of LEDs; one or more gaskets; and a lens, wherein the PCB housing, the PCB; the one or more gaskets; and the lens may be configured in a stacked assembly, and wherein the one or more gaskets provide a substantially waterproof seal.

### BRIEF DESCRIPTION OF THE DRAWINGS

Having thus described the presently disclosed subject matter in general terms, reference will now be made to the accompanying drawings, which are not necessarily drawn to scale, and wherein:

FIG. 1 and FIG. 2 illustrate an exploded view and a plan view, respectively, of a modular linear high-bay light-emitting diode (LED) light fixture in accordance with an embodiment of the invention;

FIG. 3 illustrates various views of a modular linear high-bay LED light fixture in accordance with an embodiment of the invention;

FIG. 4 and FIG. 5 illustrate an exploded view and a plan view, respectively, of a modular linear high-bay LED light fixture in accordance with an embodiment of the invention;

FIG. 6 illustrates various views of a modular linear high-bay LED light fixture in accordance with an embodiment of the invention;

FIG. 7 illustrates a perspective view of an example of an LED driver of the modular linear high-bay LED light fixture in accordance with an embodiment of the invention;

FIG. 8 illustrates various views of an example of a driver housing of the modular linear high-bay LED light fixture in accordance with an embodiment of the invention;

FIG. 9 illustrates various views of an example of a driver outer end cover modular linear high-bay LED light fixture in accordance with an embodiment of the invention;

FIG. 10 illustrates various views of an example of a driver inner end cover of the modular linear high-bay LED light fixture in accordance with an embodiment of the invention;

FIG. 11 illustrates various views of another example of the driver inner end cover of modular linear high-bay LED light fixture in accordance with an embodiment of the invention;

FIG. 12 illustrates various views of an example of an end plate of the modular linear high-bay LED light fixture in accordance with an embodiment of the invention;

FIG. 13 illustrates various views of another example of the end plate of the modular linear high-bay LED light fixture in accordance with an embodiment of the invention;

FIG. 14 illustrates various views of an example of a PCB housing of the modular linear high-bay LED light fixture in accordance with an embodiment of the invention;

FIG. 15 illustrates various views of an example of a lens of the modular linear high-bay LED light fixture in accordance with an embodiment of the invention;

FIG. 16 illustrates various views of another example of the lens of the modular linear high-bay LED light fixture in accordance with an embodiment of the invention;

FIG. 17 shows an example of a schematic diagram of the modular linear high-bay LED light fixture in accordance with an embodiment of the invention; and

FIG. 18, FIG. 19, FIG. 20, and FIG. 21 illustrate perspective views of examples of the modular linear high-bay LED light fixture that include both up-facing and down-facing LED light strips in accordance with an embodiment of the invention.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

In some embodiments, the subject matter of the invention provides a modular linear high-bay light-emitting diode (LED) light fixture. The modular linear high-bay LED light fixture may be a National Sanitation Foundation (NSF)-rated fixture that has smooth features and is easy to clean.

The modular design of the modular linear high-bay LED light fixture preferably allows for many (e.g., dozens) configurations of the LED light fixture using a relatively small selection of different components that can be arranged one to another in different ways and numbers. The core components may include, for example, an LED driver and one or more LED light strip assemblies, wherein the LED driver can drive various configurations of multiple LED light strip assemblies that support various configurations of the modular linear high-bay LED light fixture.

In some embodiments, the modular linear high-bay LED light fixture may include multiple LED light strip assemblies arranged side-by-side, multiple LED light strip assemblies arranged end-to-end, and/or multiple LED light strip assemblies arranged both side-by-side and end-to-end.

In some embodiments, the modular linear high-bay LED light fixture may include an LED driver and a configuration of four two-foot long LED light strip assemblies arranged side-by-side to form a two-foot long, four-strip high-bay LED light fixture.

In some embodiments, the modular linear high-bay LED light fixture may include an LED driver and a configuration of three two-foot long LED light strip assemblies arranged side-by-side to form a two-foot long, three-strip high-bay LED light fixture.

In some embodiments, the modular linear high-bay LED light fixture may include an LED driver and a configuration of three strips of two two-foot long LED light strip assemblies arranged end-to-end to form a four-foot long, three-strip high-bay LED light fixture.

In some embodiments, the modular linear high-bay LED light fixture may include an LED driver and a configuration of four strips of two two-foot long LED light strip assemblies arranged end-to-end to form a four-foot long, four-strip high-bay LED light fixture.

In some embodiments, the modular linear high-bay LED light fixture may include an arrangement of both up-facing and down-facing LED light strip assemblies.

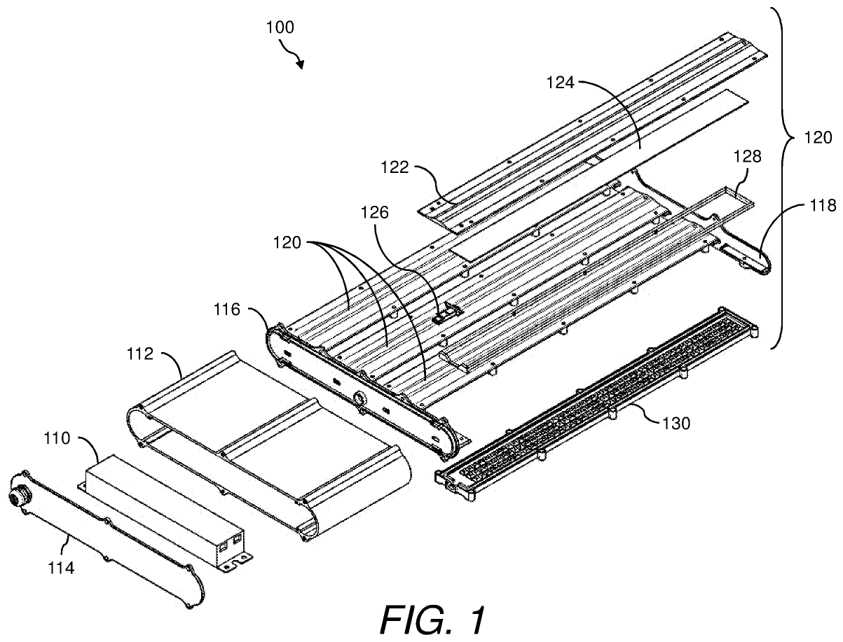

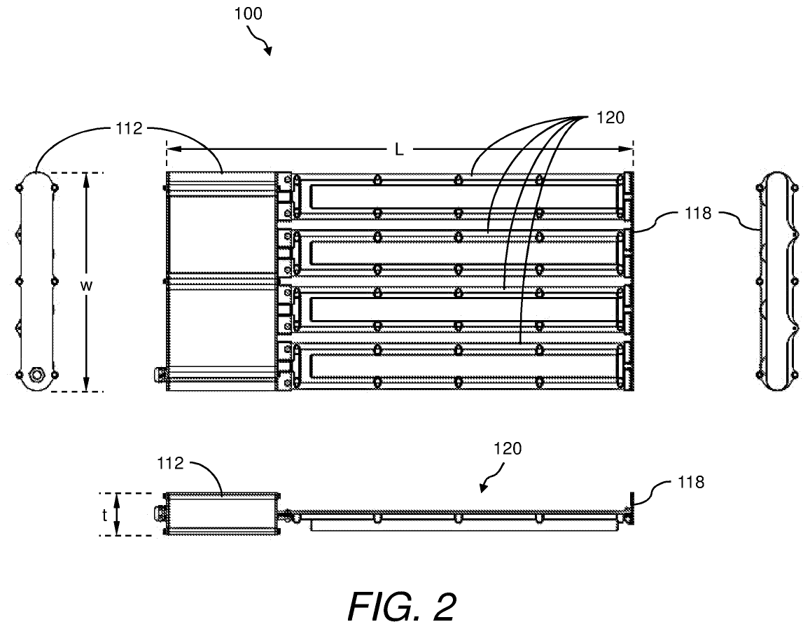

Referring now to FIG. 1 and FIG. 2 is an exploded view and a plan view, respectively, of a modular linear high-bay LED light fixture 100, which is an example of the modular linear high-bay LED light fixture according to a first configuration. Modular linear high-bay LED light fixture 100 is an example of a two-foot long, four-strip high-bay LED light fixture.

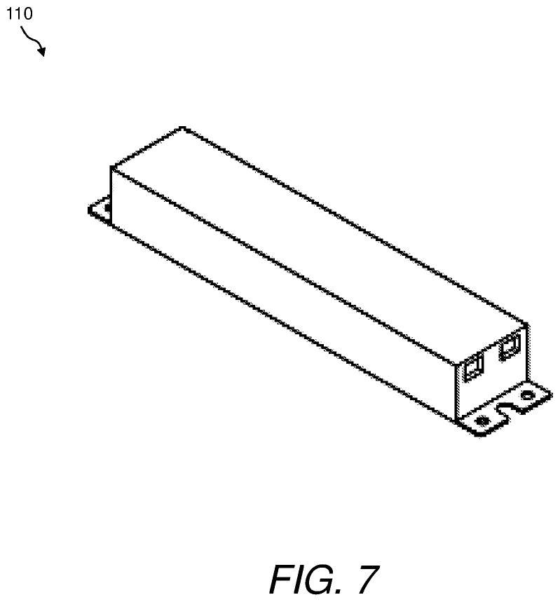

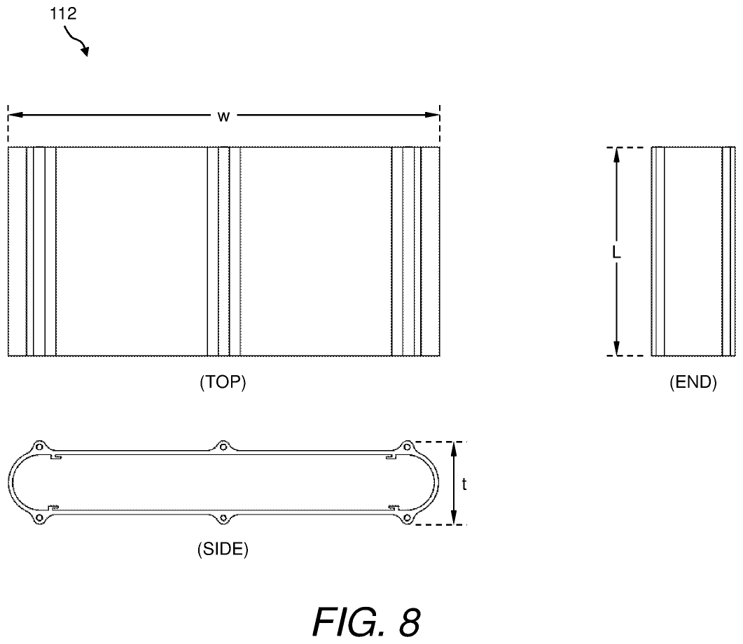

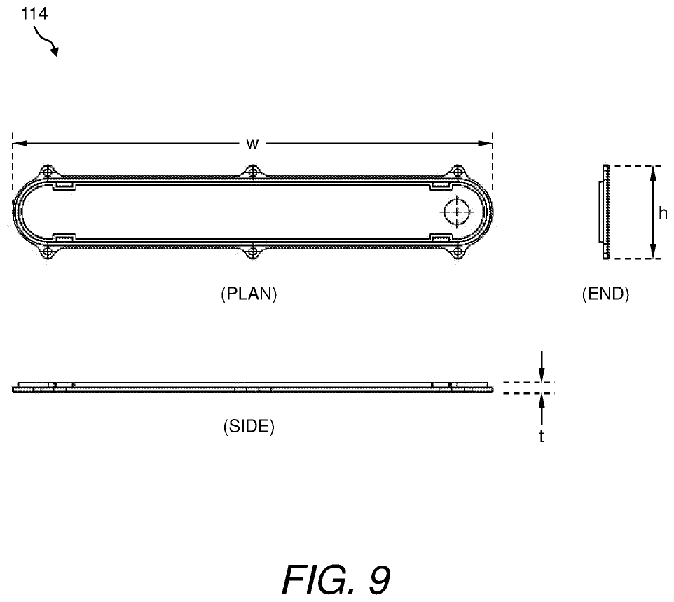

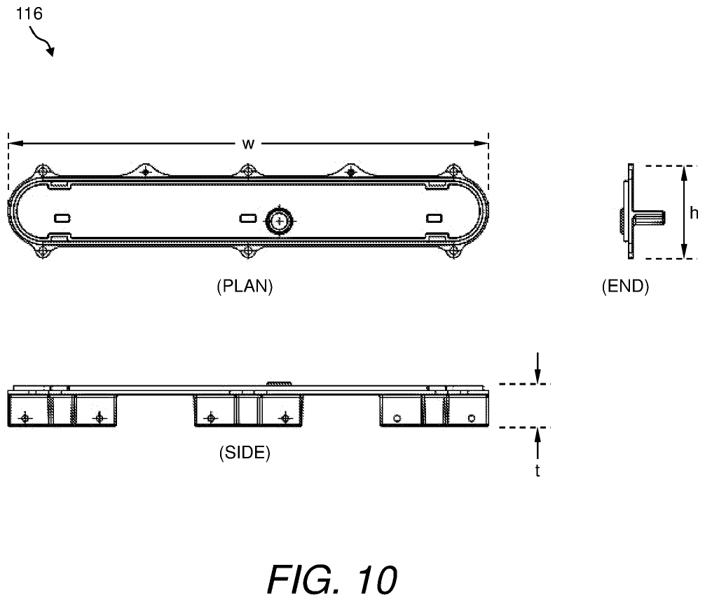

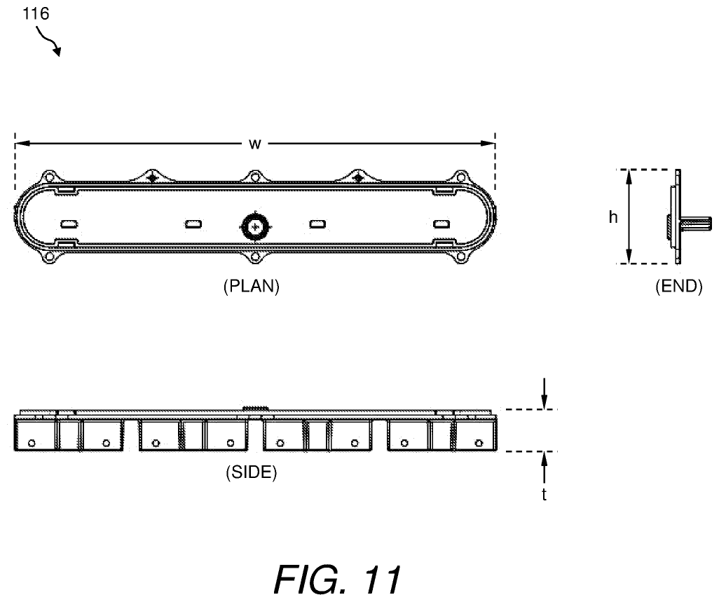

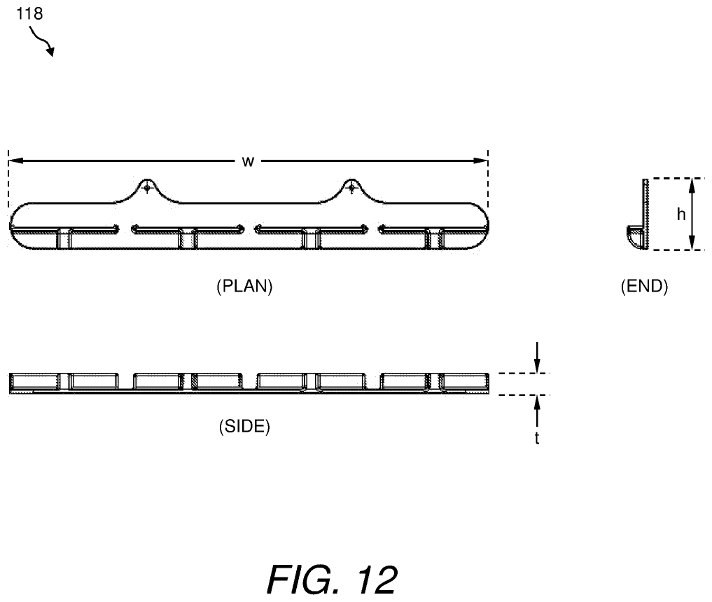

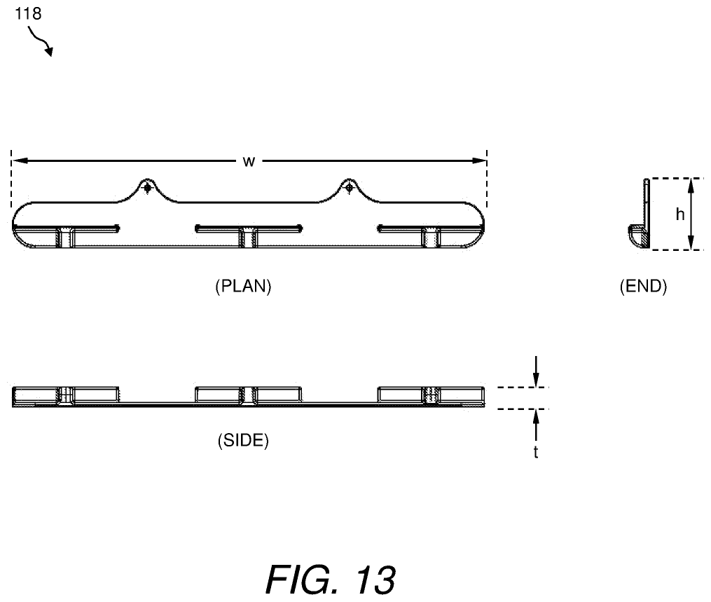

Modular linear high-bay LED light fixture 100 may include an LED driver 110 (see FIG. 7), a driver housing 112 (see FIG. 8), a driver outer end cover 114 (see FIG. 9), a driver inner end cover 116 (see FIG. 10 and FIG. 11), an end plate 118 (see FIG. 12 and FIG. 13), and a set of LED light strip assemblies 120 (e.g., four) arranged side-by-side. LED driver 110 may be mounted within driver housing 112, then driver housing 112 may be enclosed using driver outer end cover 114 and driver inner end cover 116. One end of the four LED light strip assemblies 120 may be mechanically connected to driver inner end cover 116. Further, electrical connections between LED driver 110 and the LED light strip assemblies 120 may pass through driver inner end cover 116. The opposite end of the LED light strip assemblies 120 may be mechanically connected to end plate 118. The LED light strip assemblies 120 may be, for example, snap-fitted between driver inner end cover 116 and end plate 118.

Each of the LED light strip assemblies 120 may include a stack of components.

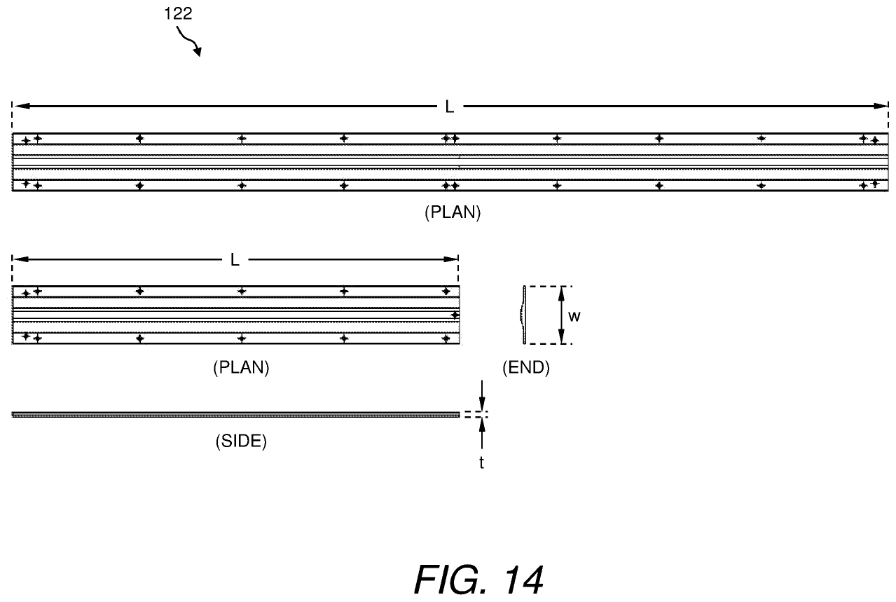

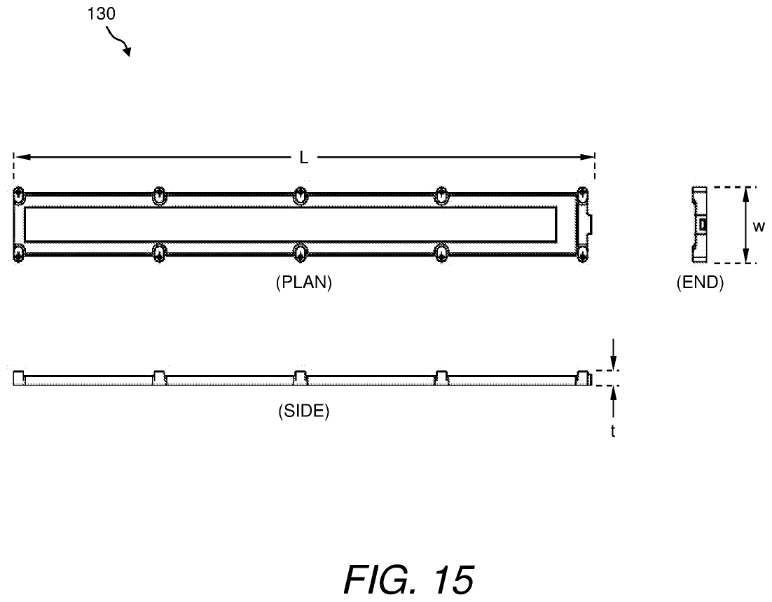

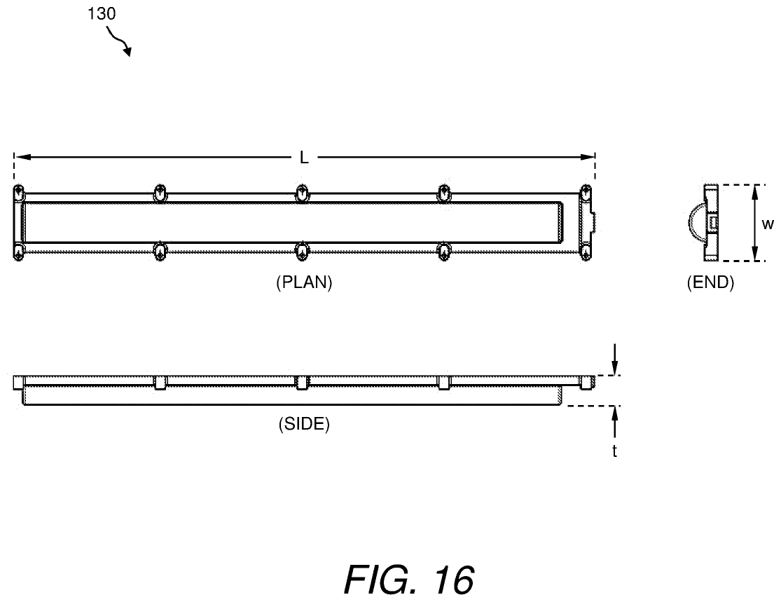

For example, each LED light strip assembly 120 may include a printed circuit board (PCB) housing 122 (see FIG. 14), a PCB 124, a wires gasket 126, a lens gasket 128, and a lens 130 (see FIG. 15 and FIG. 16), and may be arranged in that order from top to bottom.

PCB 124 may be a PCB that supports an arrangement of LEDs (e.g., white light LEDs) and for supplying power and signals to the LEDs. In one example, PCB 124 may be about 2 inches wide and about 18 inches long and may hold, for example, 144 LEDs, wherein the LEDs may be arranged, for example, in a 3×48 array (i.e., 3 rows and 48 columns) and may be spaced about 10 mm apart. Additionally, to provide good thermal and power management, PCB housing 122 and PCB 124 may be formed of an aluminum alloy, or other suitable material, that can quickly dissipate heat from the LEDs. Additionally, PCB housing 122 preferably functions to protect PCB 124. In this example, PCB housing 122 may be in the range of about 19.75 inches long (see FIG. 14).

Wires gasket 126 and lens gasket 128 may be formed, for example, of silicon rubber or other suitable material. A function of wires gasket 126 and lens gasket 128 is preferably to ensure that LED light strip assembly 120 is waterproof.

A function of lens 130 may be to adjust the shape of the light emitted by LED light strip assembly 120. Lens 130 may be formed, for example, of PC(Polycarbonate) or PMMA(Polymethylmethacrylate), or any other suitable material. Non-limiting examples of different types of lens 130 are shown hereinbelow with referenced to FIG. 15 and FIG. 16.

FIG. 2 shows a plan view, a side view, and end views of modular linear high-bay LED light fixture 100 that has a length L, a width w, and a thickness t. In one example, the length L may be in the range of about 661 mm (about 26.02 inches), the width w may be in the range of about 310 mm (about 12.2 inches), and the thickness t may be in the range of about 59 mm (about 2.32 inches).

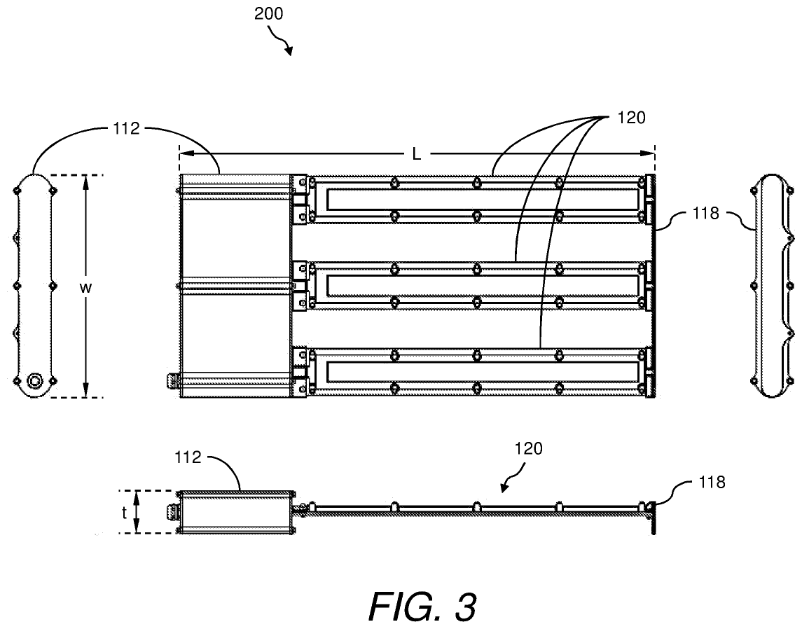

Referring now to FIG. 3 is various views of a modular linear high-bay LED light fixture 200, which is an example of the presently disclosed modular linear high-bay LED light fixture according to yet another configuration. Modular linear high-bay LED light fixture 200 is an example of a two-foot long, three-strip high-bay LED light fixture. More particularly, FIG. 3 shows a plan view, a side view, and end views of modular linear high-bay LED light fixture 200. Modular linear high-bay LED light fixture 200 is substantially the same as modular linear high-bay LED light fixture 100 shown in FIG. 1 and FIG. 2 except that it includes fewer LED light strip assemblies 120 (e.g., three) arranged side-by-side instead of, for example, four LED light strips as shown in FIG. 2. In this example of a modular linear high-bay LED light fixture 200, the length L may be in the range of about 661 mm (about 26.02 inches), the width w may be in the range of about 310 mm (about 12.2 inches), and the thickness t may be in the range of about 59 mm (about 2.32 inches).

Modular linear high-bay LED light fixture 100 of FIG. 1 and FIG. 2 and modular linear high-bay LED light fixture 200 of FIG. 3 are examples of low power LED light fixtures that may include one LED driver 110 only and therefore driver housing 112 only, with the opposite end supported by end plate 118.

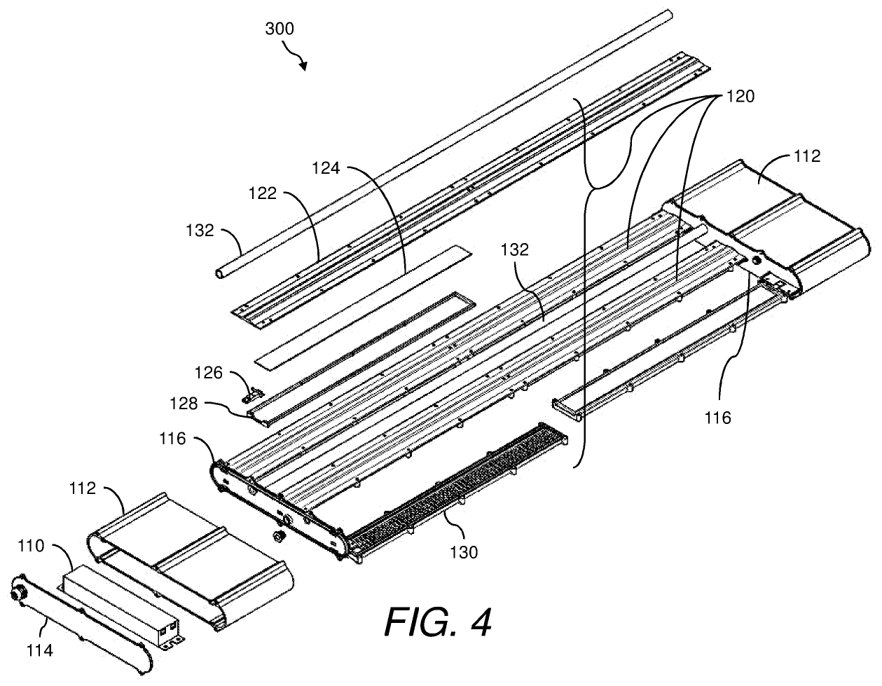

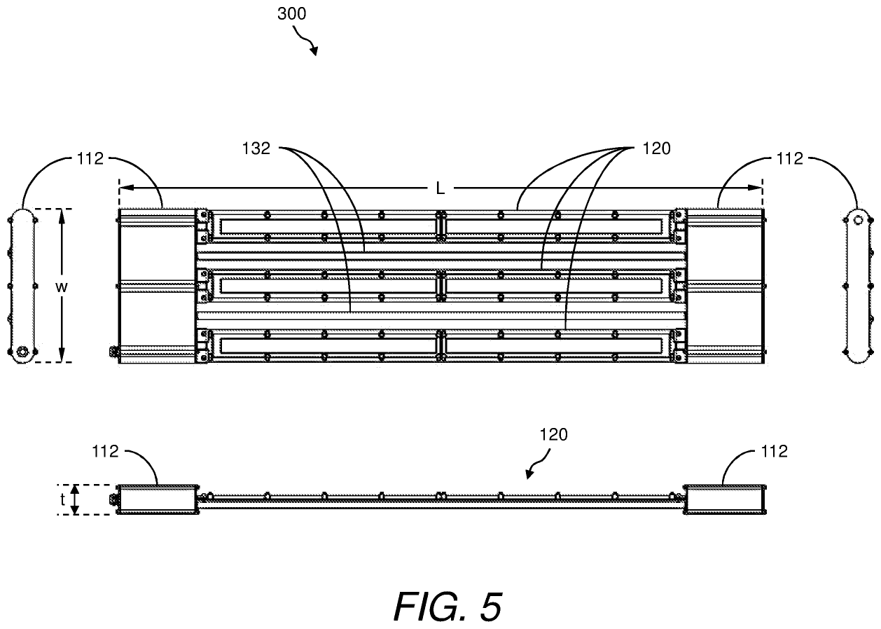

Referring now to FIG. 4 and FIG. 5 is an exploded view and a plan view, respectively, of a modular linear high-bay LED light fixture 300, which is an example of the modular linear high-bay LED light fixture according to another configuration. For example, Modular linear high-bay LED light fixture 300 may be a four-foot long, three-strip high-bay LED light fixture.

In this example, each of the three strips may include two LED light strip assemblies 120 arranged end-to-end to form the high-bay LED light fixture 300. In particular, the LED light strip assemblies 120 may be arranged end-to-end may be arranged between two driver housings 112. For example, the three strips of two LED light strip assemblies 120 arranged end-to-end can be, for example, snap-fitted between driver inner end cover 116 of the first driver housing 112 and the driver inner end cover 116 of the second driver housing 112. Further, in this example, PCB housing 122 may be in the range of about 38.75 inches long (see FIG. 14) to support two PCBs 124 arranged end-to-end. Further, in this configuration, modular linear high-bay LED light fixture 300 may include a wire conduit 132 arranged between the two driver housings 112. Wire conduit 132 may have two functions (1) for passing wires from one end of modular linear high-bay LED light fixture 300 to the other, and (2) enhance the reliability of the structure of modular linear high-bay LED light fixture 300.

In one driver configuration, while the four-foot long, three-strip high-bay LED light fixture 300 may include two driver housings 112, only one driver housing 112 may be populated with LED driver 110. That is, one LED driver 110 only may be needed to drive the three strips of two LED light strip assemblies 120 arranged end-to-end. In this example, the one LED driver 110 can connect substantially directly to the nearest LED light strip assemblies 120. Then, power and signals from the one LED driver 110 may be passed through wire conduit 132 to the far driver housing 112 and then to the far LED light strip assemblies 120.

In another driver configuration, each of the two driver housings 112 may hold an LED driver 110. That is, two LED drivers 110 are used to drive the three strips of two LED light strip assemblies 120 arranged end-to-end. In this example, the first LED driver 110 at one end can connect substantially directly to its nearest LED light strip assemblies 120. Then, the second LED driver 110 at the other end can connect substantially directly to its nearest LED light strip assemblies 120. Further, AC power can pass from one end to the other via wire conduit 132. In this example, in each strip, the two end-to-end PCBs 124 may be electrically isolated from one another.

FIG. 5 shows a plan view, a side view, and end views of modular linear high-bay LED light fixture 300. In this example of a modular linear high-bay LED light fixture 300, the length L may be about 1296 mm (about 51.02 inches), the width w may be about 310 mm (about 12.2 inches), and the thickness t may be about 59 mm (about 2.32 inches).

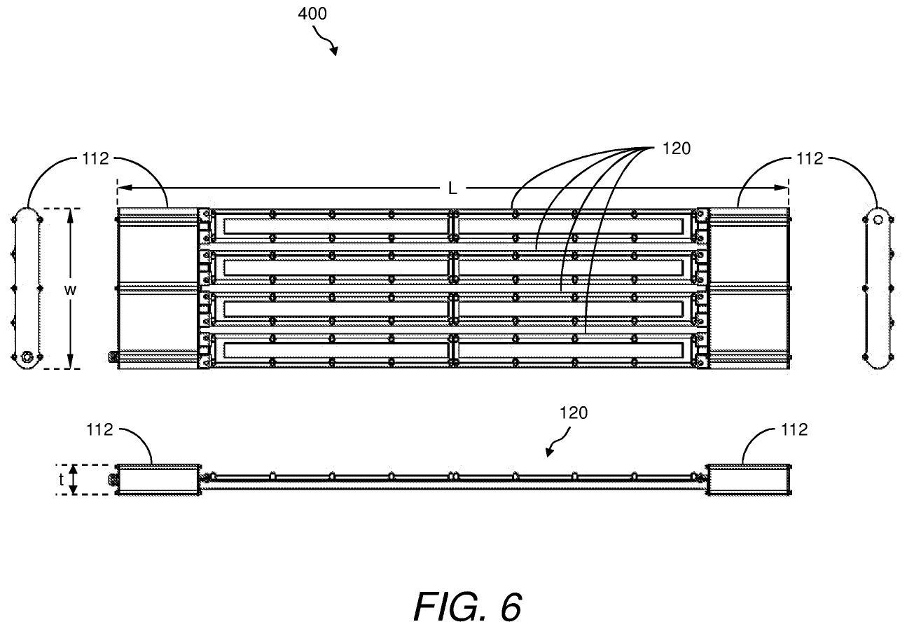

Referring now to FIG. 6 is various views of a modular linear high-bay LED light fixture 400, which is an example of the presently disclosed modular linear high-bay LED light fixture according to still another configuration. Modular linear high-bay LED light fixture 400 may be for example a four-foot long, four-strip high-bay LED light fixture. Modular linear high-bay LED light fixture 400 may be substantially the same as modular linear high-bay LED light fixture 300 shown in FIG. 4 and FIG. 5 except that it may include four strips of two LED light strip assemblies 120 arranged end-to-end instead of three strips.

FIG. 6 shows a plan view, a side view, and end views of modular linear high-bay LED light fixture 400. In this example of a modular linear high-bay LED light fixture 400, the length L may be in the range of about 1296 mm (about 51.02 inches), the width w may be in the range of about 310 mm (about 12.2 inches), and the thickness t may be in the range of about 59 mm (about 2.32 inches).

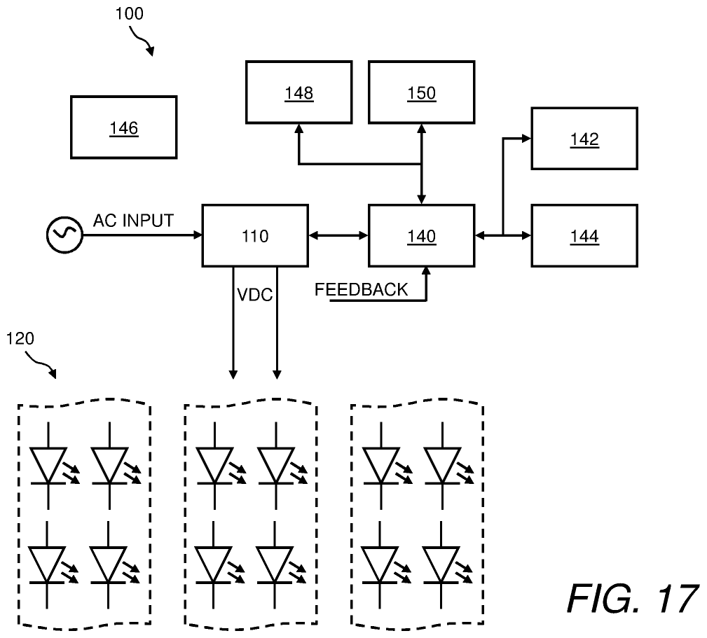

Referring now to FIG. 7 is a perspective view of an example of LED driver 110 of the presently disclosed modular linear high-bay LED light fixture 100, 200, 300, 400. In one example, LED driver 110 may be in the range of about 6 inches long, in the range of about 1.3 inches wide, and in the range of about 1.1 inches high. More details of examples of LED driver 110 are described hereinbelow with reference to FIG. 17.

Referring now to FIG. 8 is a plan view, a side view, and an end view of an example of driver housing 112 of the presently disclosed modular linear high-bay LED light fixture 100, 200, 300, 400. Driver housing 112 has a length L, a width w, and a thickness t. In one example, the length L may be in the range of about 150 mm (about 5.91 inches), the width w may be in the range of about 310 mm (about 12.2 inches), and the thickness t may be in the range of about 59 mm (about 2.32 inches).

Additionally, FIG. 9 shows a plan view, a side view, and an end view of an example of driver outer end cover 114. Driver outer end cover 114 has a height h, a width w, and a thickness t. In one example, the height h may be in the range of about 60.5 mm (about 2.38 inches), the width w may be in the range of about 310 mm (about 12.2 inches), and the thickness t may be in the range of about 26 mm (about 1.02 inches).

Additionally, FIG. 10 shows a plan view, a side view, and an end view of an example of driver inner end cover 116 that supports three-strip configurations, as shown, for example, in FIG. 3, FIG. 4, and FIG. 5. Driver inner end cover 116 has a height h, a width w, and a thickness t. In one example, the height h may be in the range of about 60 mm (about 2.36 inches), the width w may be in the range of about 310 mm (about 12.2 inches), and the thickness t may be in the range of about 6 mm (about 0.24 inches).

Additionally, FIG. 11 shows a plan view, a side view, and an end view of an example of driver inner end cover 116 that supports four-strip configurations, as shown, for example, in FIG. 1, FIG. 2, and FIG. 6. Driver inner end cover 116 may include any features and/or components for engaging LED light strip assemblies 120. Driver inner end cover 116 has a height h, a width w, and a thickness t. In one example, the height h may be in the range of about 60.49 mm (about 2.38 inches), the width w may be in the range of about 310 mm (about 12.2 inches), and the thickness t may be in the range of about 26 mm (about 1.02 inches).

Driver housing 112, driver outer end cover 114, and driver inner end cover 116 may be formed, for example, of aluminum alloy. Additionally, driver outer end cover 114 and driver inner end cover 116 may be sealed against driver housing 112 using gasket material (not shown).

Referring now to FIG. 12 is a plan view, a side view, and an end view of an example of end plate 118 that supports, for example, a four-strip configuration, as shown, for example, in FIG. 1, FIG. 2, and FIG. 6. Additionally, FIG. 13 shows a plan view, a side view, and an end view of another example of end plate 118 that supports, for example, a three-strip configuration, as shown, for example, in FIG. 3, FIG. 4, and FIG. 5. End plate 118 may include any features and/or components for engaging LED light strip assemblies 120. End plate 118 may be formed, for example, of aluminum alloy. End plate 118 has a height h, a width w, and a thickness t. In one example, the height h may be in the range of about 45 mm (about 1.77 inches), the width w may be in the range of about 310 mm (about 12.2 inches), and the thickness t may be in the range of about 13 mm (about 0.51 inches).

Referring now to FIG. 14 is two plan views, a side view, and an end view of an example of PCB housing 122 of LED light strip assembly 120 of the presently disclosed modular linear high-bay LED light fixture 100, 200, 300, 400. Namely, FIG. 14 shows an example of a PCB housing 122 that supports, for example, a two-foot long configuration, as shown, for example, in FIG. 1, FIG. 2, and FIG. 3. PCB housing 122 has a length L, a width w, and a thickness t. In this example, the length L may be in the range of about 948 mm (about 37.32 inches), the width w may be in the range of about 65 mm (about 2.56 inches), and the thickness t may be in the range of about 5 mm (about 0.2 inches).

FIG. 14 also shows an example of a PCB housing 122 that supports, for example, a four-foot long configuration, as shown, for example, in FIG. 4, FIG. 5, and FIG. 6. In this example, the length L may be in the range of about 502 mm (about 19.76 inches), the width w may in the range of be about 65 mm (about 2.56 inches), and the thickness t may be in the range of about 5 mm (about 0.2 inches). Again, PCB housing 122 may be formed of an aluminum alloy or any other suitable material. In one example, PCB 124 may be snap-fitted to lens 130. PCB 124, in one example, is essentially clamped between lens 130 and PCB housing 122.

Referring now to FIG. 15 is a plan view, a side view, and an end view of an example of lens 130. Lens 130 has a length L, a width w, and a thickness t. In one example, the length L may be in the range of about 470 mm (about 18.5 inches), the width w may be in the range of about 61 mm (about 2.4 inches), and the thickness t may be in the range of about 11 mm (about 0.43 inches). Additionally, FIG. 16 shows a plan view, a side view, and an end view of another example of lens 130. In this example, the length L may be in the range of about 470 mm (about 18.5 inches), the width w may be in the range of about 61 mm (about 2.4 inches), and the thickness t may be in the range of about 23.25 mm (about 0.92 inches).

The function of lens 130 is to adjust the shape of the light emitted by LED light strip assembly 120. Lens 130 may be formed, for example, of PC(Polycarbonate) or PMMA(Polymethylmethacrylate), or other suitable material. Further, lens 130 may be, for example, an aisle lens, a median or middle lens, or a wide lens. Lens 130 shown in FIG. 15 is an example of an “angle” lens, meaning that it can be made with different light-emitting angles, for example, in the range from about 15 degrees to about 160 degrees. Lens 130 shown in FIG. 16 is an example of a frosted lens, wherein one cannot see a single point of light, but rather a uniform light-emitting strip. Further, lens 130 may be provided with or without a Unified Glare Rating (UGR).

Referring now to FIG. 17 is an example of a schematic diagram of the presently disclosed modular linear high-bay LED light fixture 100 (or 200, 300, 400). The schematic diagram shows LED driver 110 driving the LEDs (e.g., white light LEDs) of each of the LED light strip assemblies 120. LED driver 110 may be any standard constant-current LED driver device that has, for example, a built-in analog-to-digital converter (ADC) function and that has a DC output power of, for example, in the range of from about 60 watts to about 240 watts. LED driver 110 may receive a standard AC input and then generate the required DC output to LED light strip assemblies 120. For example, the AC input to LED driver 110 may be standard 110 VAC or 277 VAC and the output of LED driver 110 may be about 50 VDC at about 1000 ma to about 5200 ma. LED driver 110 may have certain other features, such as, but not limited to, short circuit protection, over-voltage protection, and/or dimming capability. Examples of standard LED drivers suitable for LED driver 110 may include, but are not limited to, the XLG series LED driver available from MEAN WELL Enterprises Co (Taiwan) and the SLPXXX-IYYYY 120-277 W D1 S LED driver available from ARCATA ELECTRONICS INC (Shanghai).

In addition to LED driver 110 and LED light strip assemblies 120, modular linear high-bay LED light fixture 100 may include a controller 140 and a communications interface 142. Controller 140 may preferably manage the overall operations of modular linear high-bay LED light fixture 100. In one example, controller 140 may be monitoring the output of LED driver 110. For example, certain FEEDBACK from the output of LED driver 110 may allow controller 140 to monitor various characteristics that can indicate the health of each of the LED light strip assemblies 120. For example, controller 140 may monitor the output DC voltage and current to each of the individual LED light strip assemblies 120 or collectively to all the LED light strip assemblies 120. In another example, controller 140 may monitor subsections of each of the individual LED light strip assemblies 120, depending on how the PCBs 124 are designed.

Further, controller 140 may have certain operating modes. For example, there may be a “normal” operating mode and a “power saver” operating mode. The “normal” operating mode may be, for example, the full power operating mode of modular linear high-bay LED light fixture 100. The “power saver” operating mode may be, for example, the low power operating mode in which modular linear high-bay LED light fixture 100 can be turned fully off or dimmed under system control to conserve energy.

Communications interface 142 may be any wired and/or wireless communication interface for connecting to a network (not shown) and by which information may be exchanged with other devices connected to the network. Examples of wired communication interfaces may include, but are not limited to, HDMI ports, USB ports, RS232 connectors, RJ45 connectors, Ethernet, and any combinations thereof. Examples of wireless communication interfaces may include, but are not limited to, an Intranet connection, Internet, ISM, Bluetooth® technology, Bluetooth® Low Energy (BLE) technology, Wi-Fi, Wi-Max, IEEE 402.11 technology, ZigBee technology, Z-Wave technology, 6LoWPAN technology (i.e., IPv6 over Low Power Wireless Area Network (6LoWPAN)), ANT or ANT+ (Advanced Network Tools) technology, radio frequency (RF), Infrared Data Association (IrDA) compatible protocols, Local Area Networks (LAN), Wide Area Networks (WAN), Shared Wireless Access Protocol (SWAP), any combinations thereof, and other types of wireless networking protocols. An example of communication facilitated by communications interface 142 may include setting the operating mode (“normal” mode or “power saver” mode) of modular linear high-bay LED light fixture 100.

In one example, communications interface 142 may be separate from controller 140. In another example, communications interface 142 and controller 140 may be integrated into a single device.

Optionally, modular linear high-bay LED light fixture 100 may include certain status indicators 144, emergency battery backup (e.g., a rechargeable or non-rechargeable battery 146), a motion sensor 148, a light sensor 150, or any combinations thereof. Status indicators 144 may be any means for indicating any type of status information about modular linear high-bay LED light fixture 100, such as, but not limited to, visual status indicators (e.g., different colored LEDs) and/or audible status indicators (e.g., beeps, sirens). The status information may include, for example, health information about LED light strip assemblies 120 and/or operating mode information about modular linear high-bay LED light fixture 100. In one example, motion sensor 148 and/or light sensor 150 may be used for turning modular linear high-bay LED light fixture 100 on or off automatically depending on detected motion and/or detected light.

Further, in addition to driving the LED light strip assemblies 120, LED driver 110 may be used to provide power to some or all of the active components of modular linear high-bay LED light fixture 100. For example, LED driver 110 may provide power to controller 140, communications interface 142, status indicators 144, rechargeable battery 146, motion sensor 148, and/or light sensor 150.

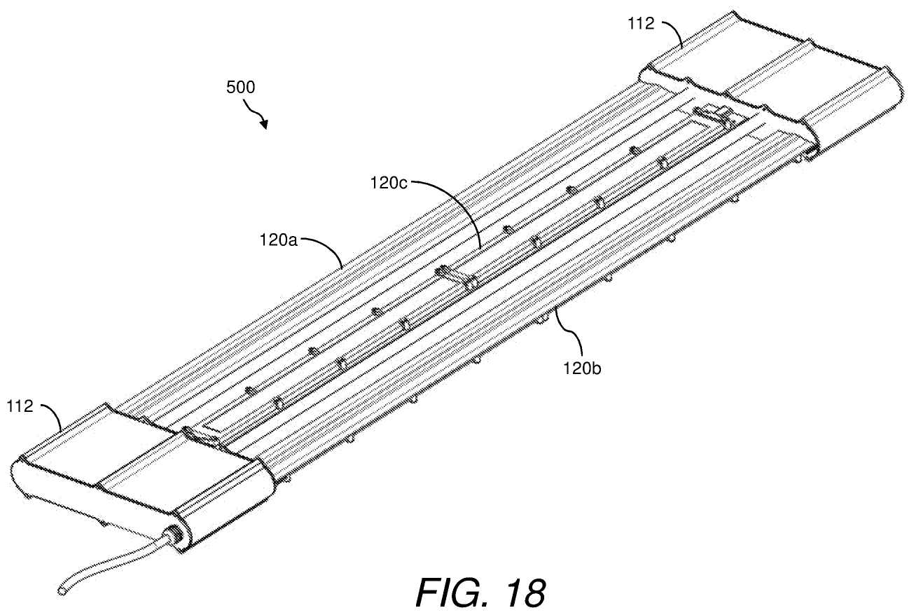

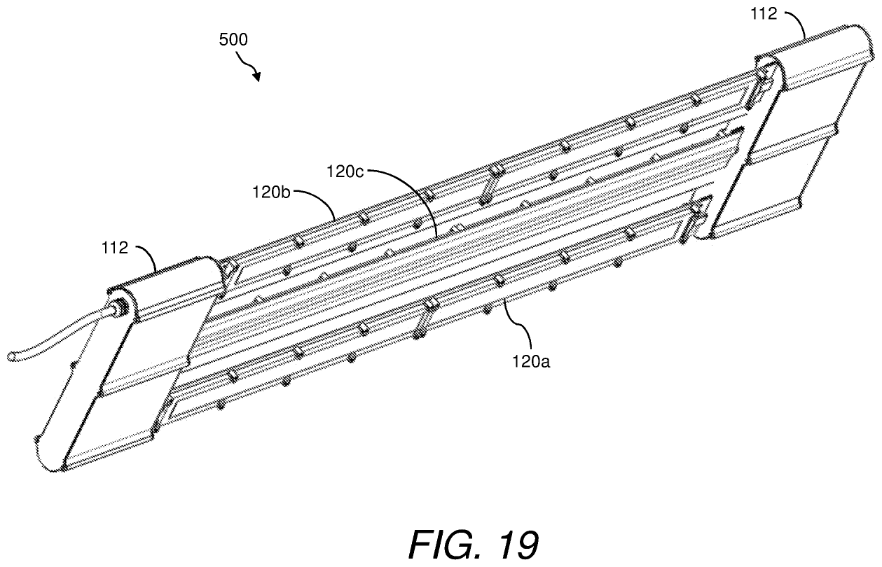

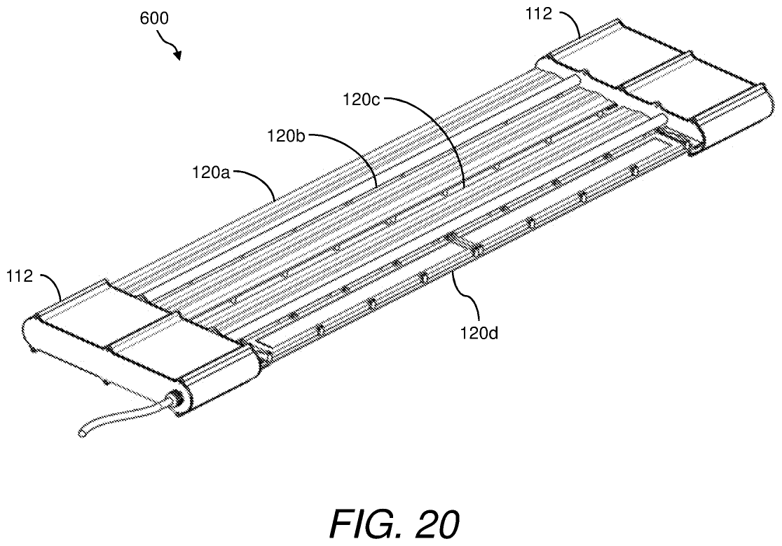

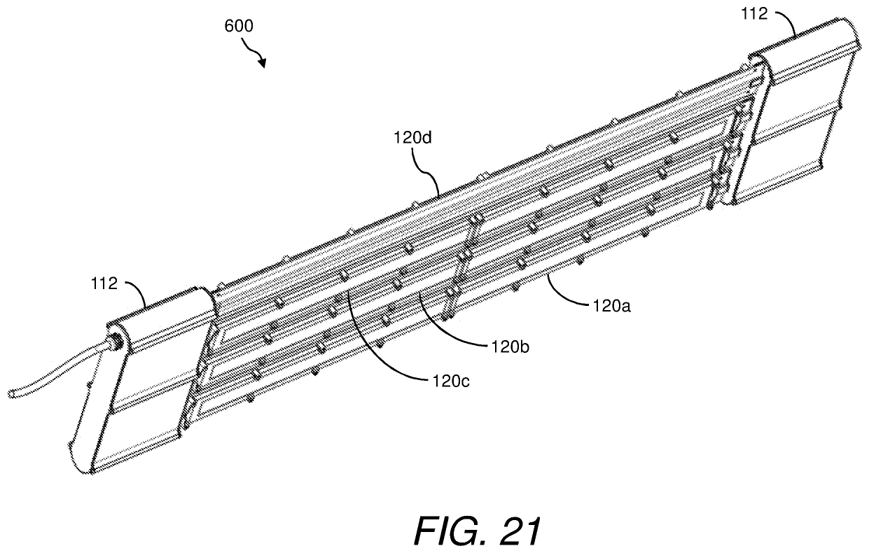

Referring now to FIG. 18, FIG. 19, FIG. 20, and FIG. 21 is perspective views of examples of the presently disclosed modular linear high-bay LED light fixture that include both up-facing and down-facing LED light strip assemblies 120. In one example, FIG. 18 and FIG. 19 show a modular linear high-bay LED light fixture 500 that includes, for example, three LED light strip assemblies 120 (e.g., 120a, 120b, 120c) arranged between, for example, two driver housings 112. In this example, LED light strip assemblies 120a and 120b may be arranged facing downward and LED light strip assembly 120c may be arranged facing upward. Further, LED light strip assembly 120c may be arranged between LED light strip assemblies 120a and 120b. However, the up-facing LED light strip assemblies 120a and 120b and the down-facing LED light strip assembly 120c may be arranged in any order. Accordingly, modular linear high-bay LED light fixture 500 may be called a 2-light strip down, 1-light strip up fixture. Further, in this example, each LED light strip assembly 120 may be, in a non-limiting example, a 100 W/15000 Lumens light strip. Accordingly, in this example, the two down-facing LED light strip assemblies 120 provides 200 W/30000 Lumens and the one up-facing LED light strip assembly 120 provides 100 W/15000 Lumens.

In another example, FIG. 20 and FIG. 21 show a modular linear high-bay LED light fixture 600 that includes, for example, four LED light strip assemblies 120 (e.g., 120a, 120b, 120c, 120d) arranged between two driver housings 112. In this example, LED light strip assemblies 120a, 120b, and 120c may be arranged facing downward and LED light strip assembly 120d may be arranged facing upward. Further, LED light strip assemblies 120a, 120b, and 120c may be arranged in order followed by LED light strip assembly 120d. However, the up-facing LED light strip assemblies 120a, 120b, and 120c and the down-facing LED light strip assembly 120d may be arranged in any order. Accordingly, modular linear high-bay LED light fixture 600 may be called a 3-light strip down, 1-light strip up fixture. Again, in this example, each LED light strip assembly 120 may be, in a non-limiting example, a 100 W/15000 Lumens light strip. Accordingly, the three down-facing LED light strip assemblies 120 provides 300 W/45000 Lumens and the one up-facing LED light strip assembly 120 provides 100 W/15000 Lumens.

Referring now again to FIG. 1 through FIG. 21, the presently disclosed modular linear high-bay LED light fixture (e.g., modular linear high-bay LED light fixtures 100, 200, 300, 400, 500, 600) provides a modular, smooth, easy to clean, NSF-rated, linear high-bay LED light fixture that features high reliability, high protection level, and high efficiency in an economical way. The presently disclosed modular linear high-bay LED light fixture can be used, for example in food processing plants, cold storage, and other harsh environments.

Other features of the presently disclosed modular linear high-bay LED light fixture (e.g., modular linear high-bay LED light fixtures 100, 200, 300, 400, 500, 600) include smooth surfaces and no radiator to minimize the accumulation of dust. In, for example, food processing plants and other clean workshops, the smooth surfaces allow easy cleaning. Additionally, the presently disclosed modular linear high-bay LED light fixture provides a high protection level for the entire fixture that allows, for example, up to about 1600 PSI water flushing from, for example, about 20 feet away. Additionally, the presently disclosed modular linear high-bay LED light fixture may be suspension-mounted and/or surface-mounted.

Referring still to FIG. 1 through FIG. 21, the presently disclosed modular linear high-bay LED light fixture is not limited to the configurations shown in modular linear high-bay LED light fixtures 100, 200, 300, 400, 500, 600. These are exemplary only. Other configurations are possible.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A modular linear high-bay light fixture, comprising:
a. one or more light-emitting diode (LED) drivers enclosed in a driver housing; and
b. one or more LED light strip assemblies operatively connected to the one or more LED drivers, wherein the one or more LED light strip assemblies each comprise a stack assembly enclosed in a substantially waterproof configuration.

2. The modular linear high-bay light fixture of claim 1, wherein the stack assembly comprises a PCB housing; a PCB comprising an arrangement of LEDs; one or more gaskets; and a lens, wherein the one or more gaskets provide a waterproof seal.

3. The modular linear high-bay light fixture of claim 2, wherein at least one of the driver housing and the PCB housing comprises an aluminum alloy.

4. The modular linear high-bay light fixture of claim 2, wherein the PCB housing is configured to dissipate heat away from the arrangement of LEDs on the PCB.

5. The modular linear high-bay light fixture of claim 2, wherein the lens is configured to adjust the shape of light emitted from the arrangement of LEDs.

6. The modular linear high-bay light fixture of claim 1, comprising a plurality of LED light strip assemblies arranged in a side-by-side configuration.

7. The modular linear high-bay light fixture of claim 6, wherein the plurality of LED light strip assemblies are operatively connected to a single LED driver.

8. The modular linear high-bay light fixture of claim 1, comprising a plurality of LED light strip assemblies arranged in an end-to-end configuration.

9. The modular linear high-bay light fixture of claim 8, wherein the plurality of LED light strip assemblies are operatively connected to a single LED driver.

10. The modular linear high-bay light fixture of claim 8, wherein at least one of the plurality of LED light strip assemblies is operatively connected to a first LED driver, and at least one of the other ones of the plurality of LED light strip assemblies is operatively connected to a second LED driver.

11. The modular linear high-bay light fixture of claim 8, wherein a first end of a first LED light strip assembly is operatively connected to a first LED driver and a second end of a second LED light strip assembly arranged in an end-to-end configuration with the first LED light strip assembly is operatively connected to a second LED driver.

12. The modular linear high-bay light fixture of claim 1, comprising a first LED light strip assembly and a second LED light strip assembly arranged in an end-to-end configuration relative to one another; and a third LED light strip assembly and a fourth LED light strip assembly arranged in an end-to-end configuration relative to one another; and wherein the first and second LED light strip assemblies are arranged in a side-by-side configuration relative to the third and fourth LED light strip assemblies.

13. The modular linear high-bay light fixture of claim 1, wherein the driver housing comprising a driver housing outer end cover; and a driver housing inner end cover.

14. The modular linear high-bay light fixture of claim 13, wherein the driver housing comprises a substantially waterproof housing.

15. The modular linear high-bay light fixture of claim 13, wherein a first end of an LED light strip assembly is mechanically coupled to the driver inner end cover and an opposite second end of a second LED light assembly, arranged in an end-to-end configuration with the first LED light strip assembly, is mechanically coupled to an end plate.

16. The modular linear high-bay light fixture of claim 8, wherein a first end of a first LED light strip assembly is mechanically coupled to a first driver inner end cover of a first driver housing and an opposite second end of a second LED light assembly, arranged in an end-to-end configuration with the first LED light strip assembly, is mechanically coupled to a second driver inner cover of a second driver housing.

17. The modular linear high-bay light fixture of claim 1, further comprising a second driver housing.

18. The modular linear high-bay light fixture of claim 1, further comprising one or more of an operations controller and a communications interface operatively connected to one or both of the one or more LED drivers and one or more LED light strip assemblies.

19. The modular linear high-bay light fixture of claim 1, further comprising one or more of a status indicator, a battery backup, a motion sensor, and a light sensor operatively connected to one or both of the one or more LED drivers and one or more LED light strip assemblies.

20. A linear high-bay light fixture, comprising one or more modular components, wherein the one or more modular components comprise one or more light-emitting diode (LED) drivers; and one or more LED light strip assemblies operatively engaged with the one or more LED drivers, and wherein the one or more LED light strip assemblies each comprise a stack assembly enclosed in a substantially waterproof configuration.

21. The linear high-bay light fixture of claim 19, wherein the stack assembly comprises a PCB housing; a PCB comprising an arrangement of LEDs; one or more gaskets; and a lens, wherein the PCB housing, the PCB; the one or more gaskets; and the lens are configured in a stacked assembly, and wherein the one or more gaskets provide a waterproof seal.
